(19) United States
(12) Patent Application Publication
(10) Pub. No.: US 2018/0359946 A1
(43) Pub. Date: Dec. 20, 2018

(54) APPARATUS FOR GROWING VEGETABLES, MUSHROOMS, ORNAMENTAL PLANTS AND THE LIKE

(71) Applicants: Daniele ROSSI, Montichiari (IT); TOMATOPIU S.R.L., Borgosatollo (IT)

(72) Inventor: Daniele ROSSI, Montichiari (IT)

(21) Appl. No.: 16/063,567

(22) PCT Filed: Dec. 16, 2016
(86) PCT No.: PCT/IB2016/057713

§ 371 Date: Jun. 18, 2018

(30) Foreign Application Priority Data
Dec. 18, 2015 (IT) 102015000084933

(51) Int. Cl. A01G 9/20; A01G 18/62; A01G 22/00; A01G 22/60; A01G 9/24; A01G 7/04; A01G 31/06

(52) U.S. Cl. CPC A01G 9/20; A01G 18/62; A01G 22/00; A01G 22/60; A01G 7/02; A01G 9/247; A01G 7/045; A01G 31/06; A01G 9/246

(57) ABSTRACT

An apparatus for growing vegetables, mushrooms, ornamental plants and the like, includes a containment framework associated with at least one technical compartment, forming internally at least one cultivation area and having at least one respective support and containment tray designed to accommodate the seeds of vegetables, mushrooms or plants to be cultivated, and elements for controlling the cultivation parameters. The control elements
include elements for controlling the climate of each cultivation area;
irrigation elements; and
lighting elements,
there being moreover management elements adapted to act on the control elements in order to control the cultivation parameters as a function of the type of vegetable, mushroom or ornamental plant to be cultivated during the germination step and during the growth step.

### TECHNICAL FIELD

The present disclosure relates to an apparatus for growing vegetables, mushrooms, ornamental plants and the like, particularly in a domestic environment.

### BACKGROUND

Currently the need is increasingly felt to produce vegetables, regardless of the seasons, and also in regions where the climate is not particularly favorable.

For this reason, methods are known and widely used which provide for control, typically in a greenhouse, of the environmental conditions (temperature, humidity, etc.) so as to allow the cultivation of vegetables in all seasons.

In any case, the adjustment of the environmental parameters in a greenhouse (light, temperature, humidity, etc.) is feasible from an economic standpoint if the external conditions, especially temperature and irradiance, are in any case favorable for these cultivations.

If the environmental conditions are particularly different from the optimum ones for cultivation, apparatuses have been proposed which are constituted by a supporting framework that forms trays on which vegetables are cultivated.

The plants, once the seed germination step has ended, are then deposited on the trays, and by controlling humidity, temperature and light they are in some way assisted during their growth and blooming steps.

The solution briefly described above, despite being valid from a conceptual standpoint, has the drawback of needing to manage separately the germination step and in any case to continuously intervene manually in order to adapt the operating parameters of the apparatus as a function of the type of product cultivated and of its growth.

This drawback is in any case acceptable in a production of an “industrial” type, for example in a greenhouse, in which it is possible to provide conveniently a region in which germination is made to occur; management of the germinated seeds is instead extremely problematic in a “domestic” environment and accordingly known apparatuses are not easily usable for the self-production of vegetables.

### SUMMARY

The aim of the present disclosure is to provide an apparatus for growing vegetables that is capable of reducing or at least drastically limiting the drawbacks noted above.

Within this aim, the present disclosure provides an apparatus for growing vegetables that is particularly suitable for domestic use and in which cultivating the most disparate types of vegetables is extremely easy and practical.

The present disclosure further provides an apparatus for growing vegetables that has an extremely limited production cost, so as to make its use advantageous also from an economic standpoint.

These aims and advantages that will become better apparent hereinafter, are achieved by providing an apparatus for growing vegetables according to the provisions of claim 1.

### BRIEF DESCRIPTION OF THE DRAWINGS

Further characteristics and advantages of the disclosure will become better apparent from the description of some preferred but not exclusive embodiments of an apparatus for growing vegetables, particularly for domestic use, illustrated by way of non-limiting example in the accompanying drawings, wherein:

FIG. 1 is a front view of the apparatus according to the disclosure;

FIG. 2 is a front view of the apparatus in which the closure door has been omitted for the sake of greater clarity;

FIG. 3 is a plan view of the support tray;

FIG. 4 is a sectional view, taken along the plane of arrangement defined by the line IV-IV of FIG. 3;

FIG. 5 is a sectional view, taken along the plane of arrangement defined by the line V-V of FIG. 3;

FIG. 6 is an enlarged-scale sectional view of a single cultivation area along the plane of arrangement defined by the line IV-IV of FIG. 3; and

FIG. 7 is a sectional view, taken along a plane that is substantially parallel to the front plane of the technical compartment.

### DETAILED DESCRIPTION OF THE DRAWINGS

In the exemplary embodiments that follow, individual characteristics, given in relation to specific examples, may actually be interchanged with other different characteristics that exist in other exemplary embodiments.

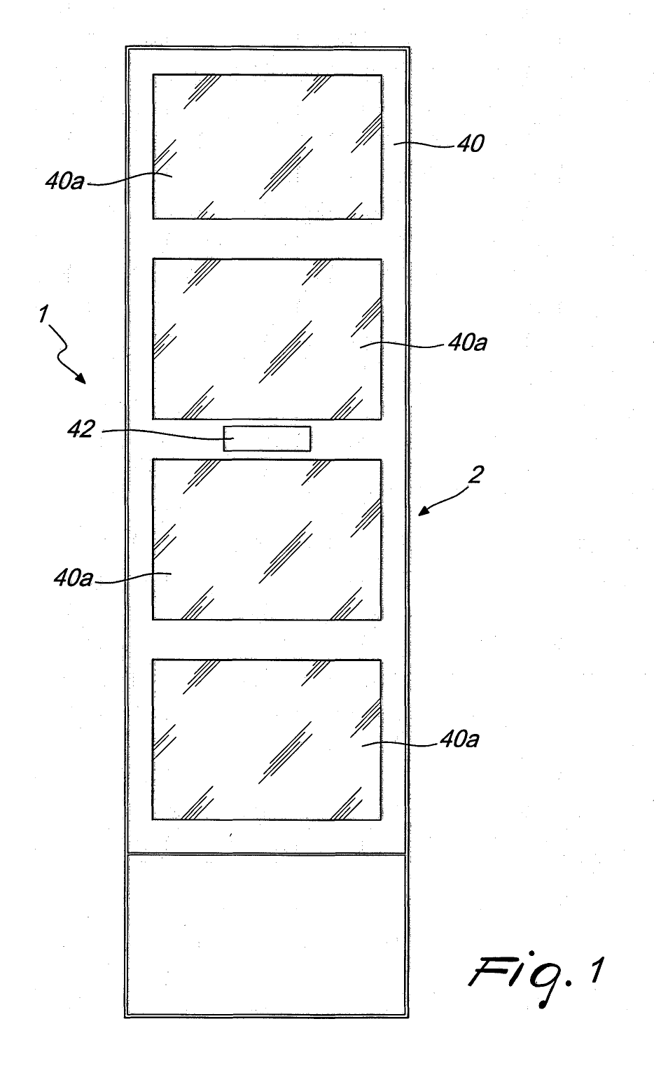

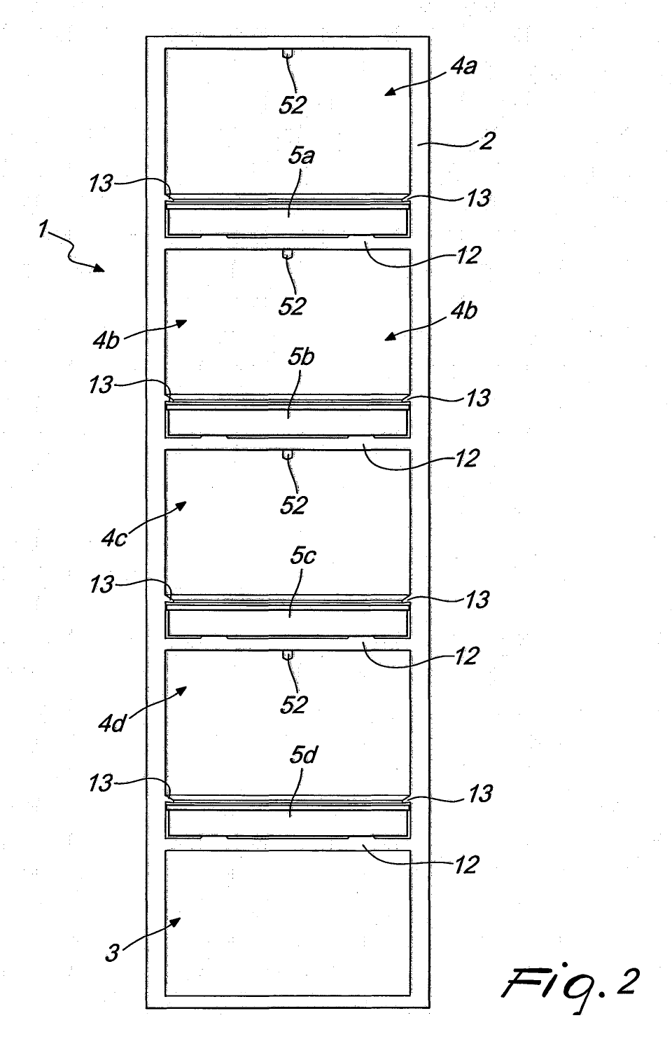

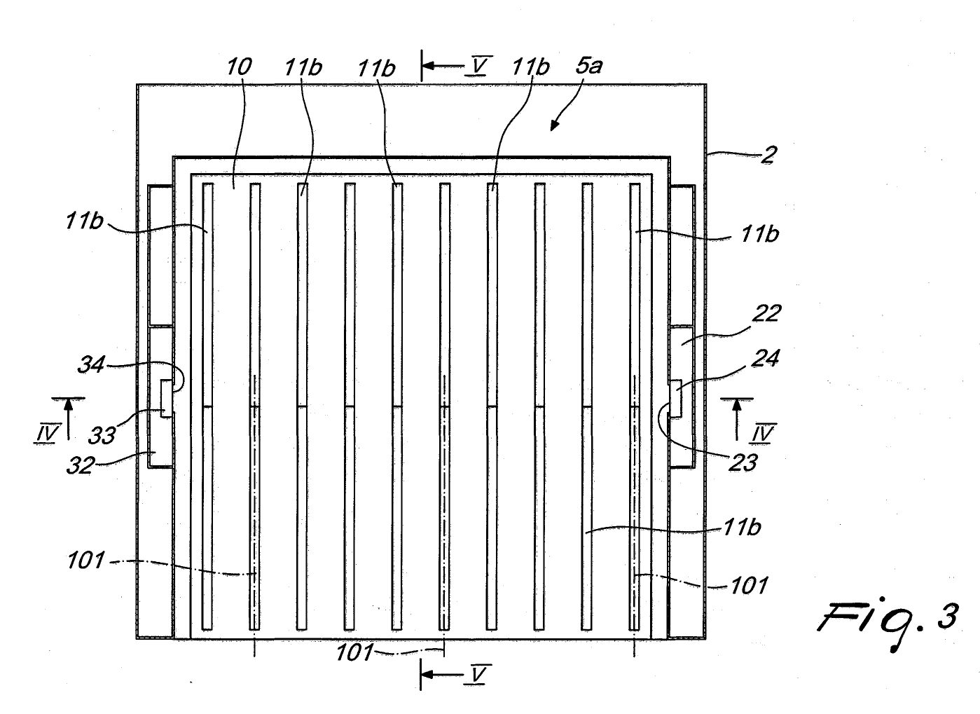

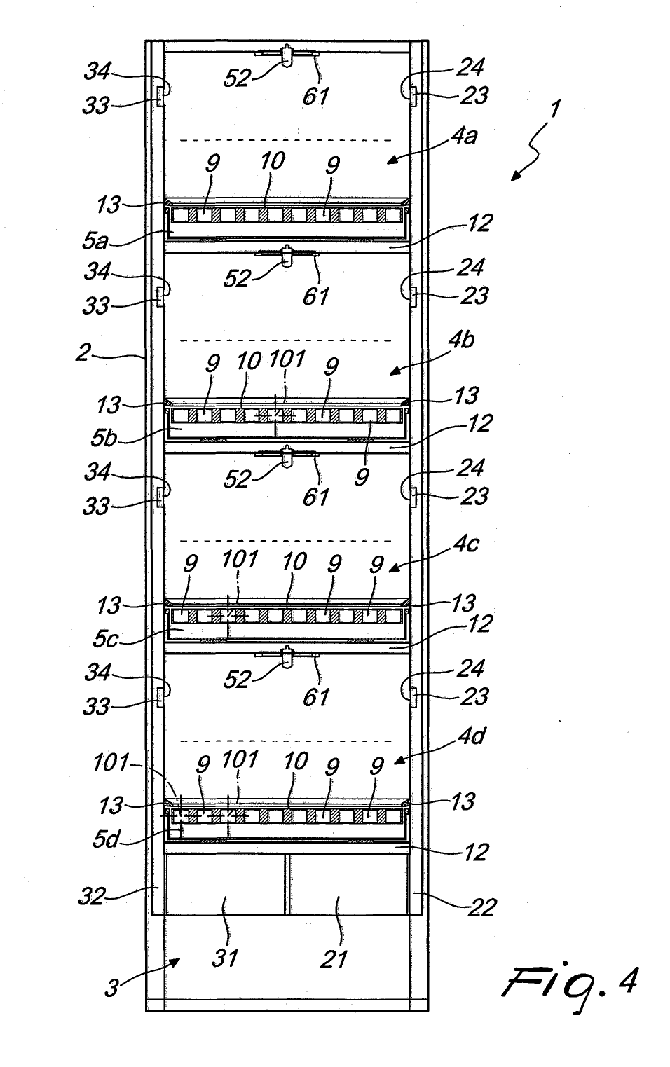

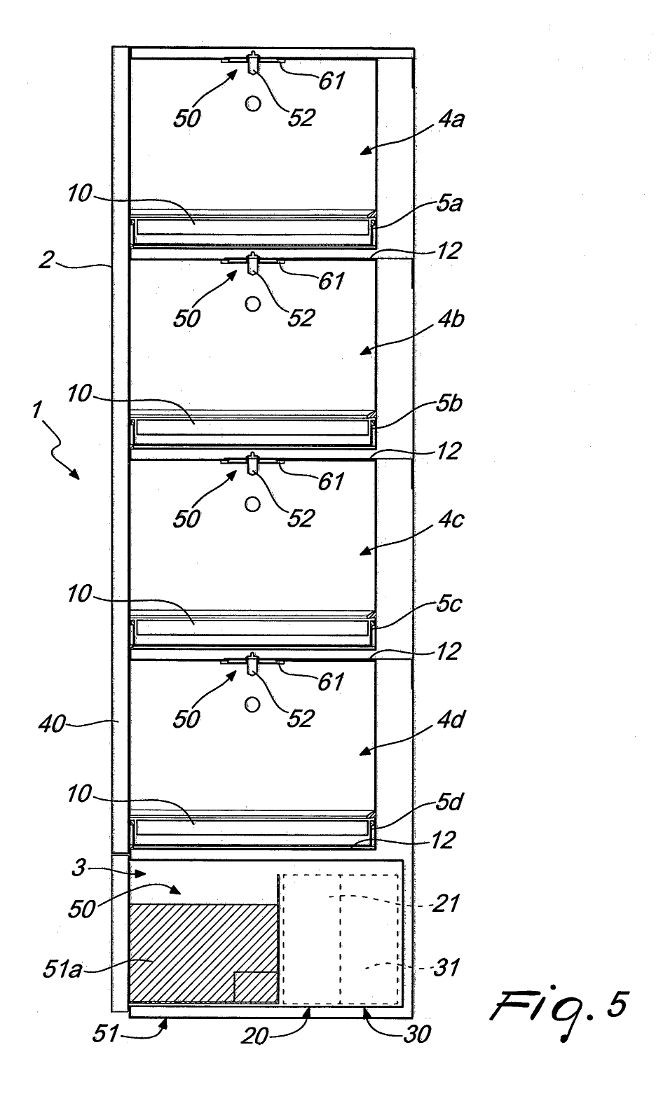

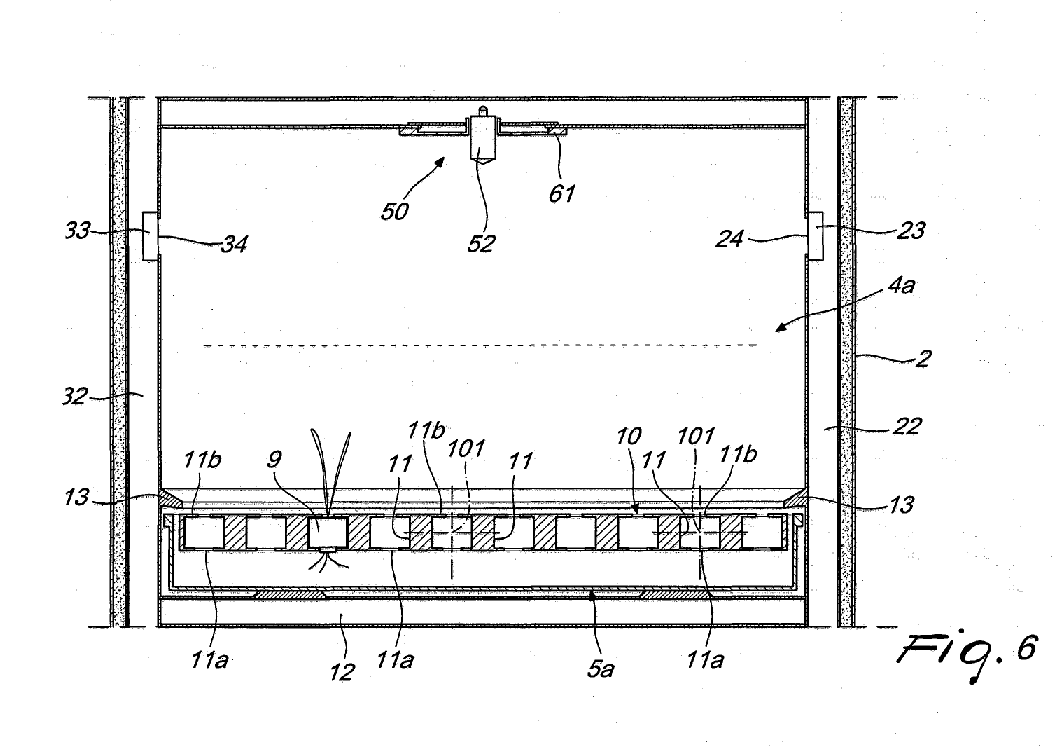

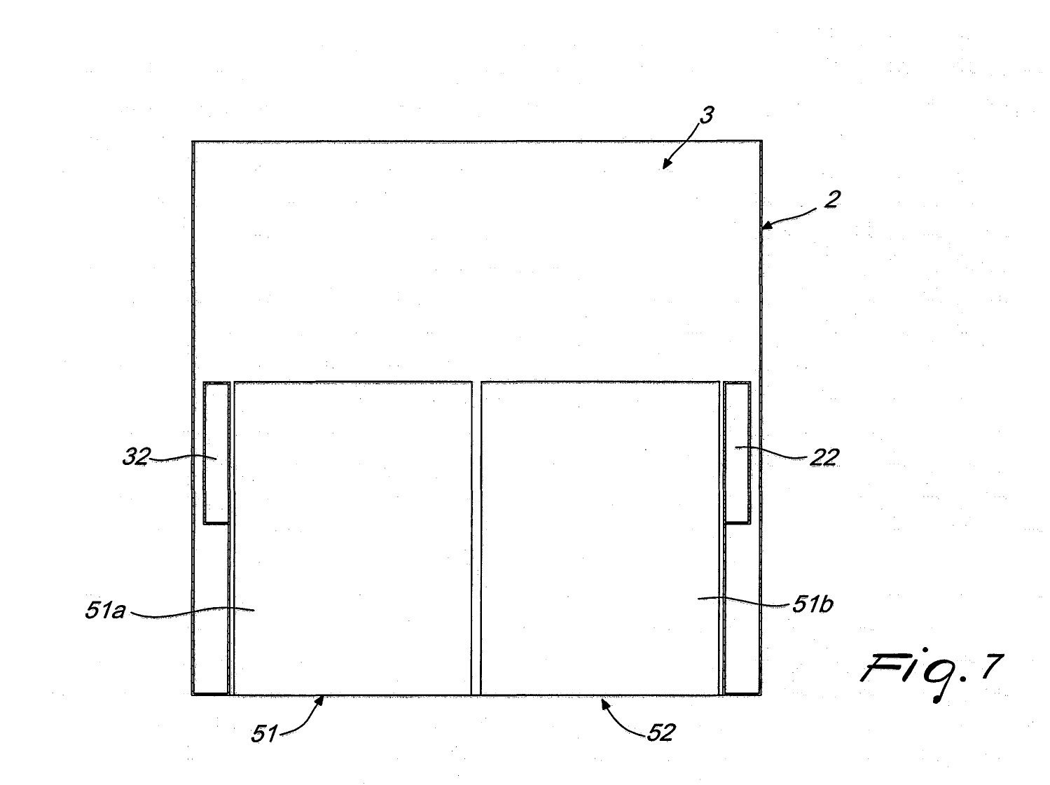

With reference to FIGS. 1-7 , the present disclosure relates to an apparatus, designated generally by the reference numeral 1, for growing is vegetables, mushrooms, ornamental plants and the like.

The apparatus 1 comprises a containment framework 2 associated with at least one technical compartment 3.

The containment framework 2 forms internally at least one cultivation area 4a, 4b, 4c, etc., which has at least one respective support tray 5a, 5b, 5c, etc., which is designed to accommodate the seeds of vegetables to be cultivated.

Conveniently, each support tray 5a, 5b, 5c, etc. is designed to contain an aqueous solution.

The containment trays 5a, 5b, 5c, etc. can also be designed to contain soil or organic material suitable for cultivation.

Advantageously, the containment framework 2 forms internally at least two cultivation areas 4a, 4b, 4c, etc..

According to the present disclosure, the apparatus 1 comprises means for controlling the cultivation parameters.

In particular, the control means are adapted to allow independent control of the cultivation parameters of each cultivation area 4a, 4b, 4c, etc.

These control means comprise:
means for climate control of each cultivation area;
irrigation means; and
lighting means.

Management means are further provided which are adapted to act on the control means in order to control the cultivation parameters as a function of the type of vegetable to be cultivated.

In particular, the management means are adapted to act on the control means in order to control the cultivation parameters during the germination step, during the growth step and optionally during the blooming step.

Preferably, the management means are adapted to act on the control means in order to control the cultivation parameters independently for each cultivation area 4a, 4b, 4c, etc.

In particular, the climate control means comprise:

first means for adjusting the temperature of each cultivation area 4a, 4b, 4c, etc.; and

second means for adjusting the humidity of each cultivation area 4a, 4b, 4c, etc..

The control means may further comprise third means for adjusting the temperature of the aqueous solution.

The first temperature adjustment means can comprise a refrigeration device 20 which has a refrigeration unit 21, accommodated preferably in the technical compaitlilent 3 and functionally connected to a cold air supply duct 22.

Conveniently, the technical compartment 3 is formed at a lower region of the containment framework 2.

The cold air supply duct 22 is associated functionally with a first fan and has a fluid connection, through respective cooling ducts 23, to each cultivation area 4a, 4b, 4c, etc.

Along the cooling ducts 23 there are conveniently first partitions 24 functionally associated with the management means; the first partitions 24 are adapted to pass between at least one open position, in which they allow the cold air flow to exit within the respective cultivation compartment 4a, 4b, 4c, etc., and a closure position, in which they prevent the cold air flow that arrives from the cold air supply duct 22 from exiting into the respective cultivation area 4a, 4b, 4c, etc.

The first partitions 24 may also be lockable in at least one position that is intermediate between the open position and the closure position so as to allow to throttle the flow of cold air.

The first temperature adjustment means can further comprise a ventilation device, which comprises for example one or more fans, designed to introduce air from the outside of the apparatus 1 into each compartment.

As an alternative, or as a replacement of the ventilation means, the first temperature adjustment means can comprise an air heating device 30 which has a heating unit 31, preferably accommodated in the technical compartment 3 and functionally connected to a warm air supply duct 32.

The warm air supply duct 32 is functionally associated with a second fan and has a fluid connection, by means of respective heating ducts 33, to each cultivation area 4a, 4b, 4c, etc.

Along the heating ducts 33 that are conveniently second partitions 34 which are functionally associated with the management means; the second partitions 34 are adapted to pass between at least one open position, in which they allow the warm air flow to exit inside the respective growing compartment 4a, 4b, 4c, etc., and a closure position, in which they prevent the warm air flow that arrives from the warm air supply duct 32 from exiting inside the respective cultivation area 4a, 4b, 4c, etc.

It is further possible to provide that the second partitions 34 can be locked in at least one position that is intermediate between the open position and the closure position so as to allow a throttling of the warm air flow.

The first temperature adjustment means further comprise at least one temperature sensor, which is functionally connected to the control means so as to control the actuation of the cooling device 20 or of the heating device 30 if the measured temperature differs from the one intended in that given cultivation area 4a, 4b, 4c, etc. for that type of cultivation and in that given time interval starting from sowing.

The second means for adjusting the humidity of each cultivation area 4a, 4b, 4c, etc. can, for example, be constituted essentially by the ventilation device and/or by the cooling device 20 and/or by the heating device 30 described above.

The second humidity adjustment means further comprise at least one hygrometer, which is functionally connected to the control means so as to control the actuation of the various devices (ventilation, cooling, heating or irrigation) if the measured degree of humidity differs from the one intended in is that given cultivation area 4a, 4b, 4c, etc. for that type of cultivation and in that given time interval starting from sowing.

The seeds can be contained within blocks 9 made of organic or non-organic material which is conveniently receptive for water (for example rock wood, peat mixtures, polyurethane foams), organic materials made of natural fibers, and packaged in vacuum in order to extend their useful life.

Conveniently, each support tray 5a, 5b, 5c, etc. forms a receptacle that is designed to contain an aqueous solution.

Advantageously, the apparatus comprises at least one seed accommodation body, which can be associated with a respective support tray 5a, 5b, 5c, etc.

Each accommodation body is provided with a base body 10, preferably made of plastic or expanded material, which forms a plurality of accommodation seats 11 which can be engaged selectively by one or more blocks 9 that contain one or more seeds.

By way of example, the base body comprises a substantially planar element that is designed to be rested on a respective tray 5a, 5b, 5c, etc. and to float optionally on the aqueous solution contained in said tray 5a, 5b, 5c, etc.

In a first embodiment (not shown in the figures), the accommodation seats 11 can be constituted by respective through openings that are formed in the base body 10 and are designed to extend around an axis that is substantially perpendicular to the plane of arrangement of the base body 10.

In this case, it is convenient to provide the outer lateral surface of the blocks 9 so that it corresponds substantially to the inner lateral surface of the io through openings formed in the base body 10.

The blocks 9 may have an external containment body, conveniently made of biodegradable material, which forms a receptacle for the organic or inorganic material and for the seeds.

The accommodation seats optionally not engaged by respective blocks is 9 can be conveniently associated with closure plugs which are adapted to protect the water from the light in order to prevent the forming of algae or to limit its evaporation.

With reference to a preferred embodiment, which is shown in the accompanying figures, the base body 10 is provided with at least one accommodation seat 11 which is extended parallel to the plane of arrangement of the base body 10 and is designed to accommodate at least one respective block 9.

Preferably, the accommodation seats 11 have at least one first region 11a, which is open downward and is designed to keep the respective block 9 in contact with the aqueous solution contained in the supporting tray 5a, 5b, 5c, etc. and at least second regions 11b, which are open upward at the position of the seeds in the block 9 that can be inserted therein so as to allow the growth of the plant.

Conveniently, the base body 10 forms a plurality of accommodation seats 11 which are extended along a main direction of extension 101 and are arranged so as to face each other.

In this case, the second region 11b of each accommodation seat 11 can comprise a longitudinal slot.

Likewise, the first region 11a of each accommodation seat 11 also can comprise a longitudinal slot.

In the specific case, the blocks 9 comprise respective elongated bodies which have an external surface that substantially corresponds to the internal surface of the respective accommodation seat 11.

The accommodation seat 11 may also have a portion that is contoured to allow the insertion of the respective elongated body so as to ensure that the seeds contained therein are arranged correctly (i.e., upward).

This solution allows, as a function of the type of vegetable to be cultivated in each cultivation area 4a, 4b, 4c, etc., to vary the density of the seeds according to the requirements.

The supporting framework 2 has a boxlike body which forms a front access opening that can be closed by means of a closure door or leaf 40.

Conveniently, the closure door 40 is provided with portions 40a which are at least partially transparent in order to allow the user to check the state of advancement of the cultivations without the need to open the closure door 40 continuously.

Conveniently, the trays 5a, 5b, 5c, etc. are mounted on longitudinal guides so as to facilitate their extraction.

The longitudinal guides can comprise a lower supporting body 12 and a pair of lateral profiles 13.

Advantageously, the irrigation means 50 comprise an irrigation device of the hydroponic type 51 and an irrigation device of the overhead type 52.

In particular, the irrigation device of the overhead type is adapted to dispense a solution of water and optionally of germinating agent during the germination step.

For example, the irrigation device of the overhead type is used in the very first days (for example 2-3) after the deposition of the seed or seeds in the respective tray 5a, 5b, 5c, etc. in order to facilitate the germination step.

The irrigation device of the overhead type can comprise an atomizer which is adapted to perform, in addition to the irrigation function, also the humidity adjustment function. As an indication, it is possible to provide between two and eight activations of the overhead irrigation device per day, depending on the type of vegetable, for a time that is comprised by way of indication between 20 seconds and 270 seconds.

If an atomizer is used to perform irrigation of the overhead type, the number of activations and their duration can be extremely variable as a function of the type of vegetables and the duration and frequency of the activation is managed automatically as a function of the degree of humidity that must be maintained.

Conveniently, the irrigation device of the overhead type 52 is autonomous with respect to the irrigation device of the hydroponic type 51 and comprises a first tray 52a for containing the aqueous solution and optionally the germinating agent which is associated with a respective first pump which is connected, by means of respective first ducts, to dispensing nozzles 52b arranged above each tray 5a, 5b, 5c, etc.

The irrigation device of the overhead type 51 can be also used as second humidity adjustment means.

The first tray 52a is advantageously accommodated within the technical compartment 3.

Along each duct there is a respective electric valve, which is connected functionally to the management means, so as to be able to control independently the overhead irrigation means 52 associated with each cultivation area 4a, 4b, 4c, etc.

The irrigation means of the hydroponic type 51 comprise a second containment tray 51a for the aqueous solution and the fertilizer, which is associated with a respective second pump connected to respective second delivery ducts 51b that lead into each tray 5a, 5b, 5c, etc.

The second tray 51a also is advantageously accommodated within the technical compartment 3.

Along each second duct there is a respective electric valve, which is functionally connected to the management means, so as to be able to control independently the hydroponic irrigation means associated with each cultivation area 4a, 4b, 4c, etc.

The germinating agent and/or the fertilizing agent may be in the form of a pellet or can be arranged in a pre-dosed manner within biodegradable or water-soluble containment bags.

The hydroponic irrigation device 51 can also be associated with a device for the management and control of pH and to an oxygenation pump.

Preferably, the hydroponic irrigation device 51 is adapted to dispense an aqueous solution of water and fertilizing agent during the growth step and is the blooming step.

Furthermore, the irrigation means 50 can be associated with a device for the automatic dosage of carbon dioxide and with an oxygen dosage device.

The apparatus 1 can be associated with an antibacterial device. By way of example, it is possible to use an apparatus that uses high-frequency electrical waves.

Conveniently, the lighting device comprises at least four types of LED lights 61, which comprise LEDs in the color “Green”, LEDs in the color “Red”, LEDs in the color “Far Red”, LEDs in the color “Royal blue”.

Advantageously, the lighting device is provided with further types of LED lights, and in particular UVA and UVB LEDs.

Specifically, the management means comprise a device for the management of each type of LED light.

The four or more types of LED light 61 indicated above are preferably arranged in each one of the cultivation compartments 4a, 4b, 4c, etc., preferably at the lower surface of the lower supporting body 12.

The LED lights 61 associated with each one of the cultivation compartments 4a, 4b, 4c, etc. may be controlled and adjusted by the control means as a function of the vegetables grown in said cultivation area 4a, 4b, 4c, etc., optimizing the natural growth process by simulating sunlight.

This allows to maintain the biological and chemical characteristics of the plant without alterations.

In the case of rapid growth with CO2, the control means act on the LED lights, automatically modifying their parameters indeed to facilitate rapid growth, in this case also maintaining the biological and chemical characteristics of the plant without alterations.

The lighting means can be programmed so as to optimize the steps of the growth of the plant, i.e., the germination step, the growth step and the blooming step.

Conveniently, the lighting means are functionally associated with a spectrophotometer for reading natural light, so as to be able to compensate or correct the quantity of artificial light emitted by the LED lights 61 during the steps of germination, growth or blooming of the plant, furthermore containing energy consumption.

The control means can also control the lighting means in order to simulate moonlight as well, thus influencing positively the germination process of the seeds and the subsequent steps.

The management means are associated with a device 42 for user entry of data related to the type of seed associated in the respective trays 5a, 5b, 5c, etc.

The management means are functionally connected to the control means so as to allow an adjustment of all the cultivation parameters (humidity, temperature, light, irrigation) independently for each cultivation area 4a, 4b, 4c, etc. automatically 24 hours a day.

The present disclosure also relates to a method for growing vegetables by means of the apparatus described above.

The method provides:

a step of accommodating the seeds on a respective tray 5a, 5b, 5c, etc.;

a step of inserting pre-dosed fertilizing agent (for example in pellet form) in the second containment tray 52a;

optionally, a step of inserting pre-dosed germinating agent in the first containment tray 51a;

a step of optional addition of water in the first and second trays 51a, 52a, until a predefined level is reached;

a step of selecting the cultivation compartment that corresponds to the tray on which the seeds have been accommodated (for example: tray 1—tray 2—etc.); and

a step of selecting the cultivation that corresponds to the accommodated seeds (for example: salad—basil—spinach—etc.).

It is optionally possible to provide a step for selecting the “speed” option in order to reduce cultivation time if the CO₂ bottle is installed.

By pressing enter, the management means control over time the means for the control of the cultivation parameters on the basis of the information contained within a data bank and extrapolated for that given cultivation.

Preferably, the management means are connected remotely to a remote controller to perform diagnostics and to receive a software update or new cultivation parameters.

In practice it has been found that the disclosure has achieved its intended aims and advantages in all of the embodiments.

In practice, the materials used, as well as the contingent shapes and dimensions, may be any according to requirements.

All the details may further be replaced with other technically equivalent elements.

The disclosures in Italian Patent Application no. 102015000084933 (UB2015A009154), from which this application claims priority, are incorporated herein by reference.

1-10. (canceled)

11. An apparatus for growing vegetables, mushrooms, or ornamental plants, the apparatus comprising a containment framework associated with at least one technical compartment, forming internally at least one cultivation area and having at least one respective support and containment tray designed to accommodate the seeds of vegetables or plants to be cultivated, further comprising means for controlling cultivation parameters, said control means comprising:
means for controlling the climate of each cultivation area;
irrigation means and
lighting means,
there being moreover management means adapted to act on said control means in order to control the cultivation parameters as a function of the type of vegetable to be cultivated during the germination step and during the growth step.

12. The apparatus according to claim 11, wherein said containment framework forms internally at least two cultivation areas, said management means being adapted to act on said control means in order to control the cultivation parameters independently for each cultivation area as a function of the type of vegetable to be cultivated during the germination step and during the growth step.

13. The apparatus according to claim 11, wherein said irrigation means comprise an irrigation device of the hydroponic type and an irrigation device of the overhead type.

14. The apparatus according to claim 13, wherein said irrigation device of the overhead type is adapted to dispense a solution of water at least during said germination step.

15. The apparatus according to claim 11, wherein said lighting device comprises at least four types of LED lights, comprising LEDs in the color “Green”, LEDs in the color “Red”, LEDs in the color “Far Red”, LEDs in the color “Royal blue”, said management means comprising a device for managing each individual type of LED light.

16. The apparatus according to claim 11, wherein said management means are associated with a device for user entry of data related to the type of seed, said management means being adapted to control said control means as a function of said type of seed.

17. The apparatus according to claim 11, wherein said means for controlling the climate comprise:
first means for adjusting the temperature of each cultivation area; and
second means for adjusting the humidity of each cultivation area.

18. The apparatus according to claim 11, wherein each support and containment tray defines a receptacle designed to contain an aqueous solution.

19. The apparatus according to claim 11, further comprising at least one seed accommodation body that can be associated with a respective support and containment tray, each accommodation body having a base body that forms a plurality of accommodation seats that can be selectively engaged by one or more blocks containing one or more seeds.

20. The apparatus according to claim 19, wherein said base body has at least one accommodation seat that is extended parallel to the plane of arrangement of said base body and is designed to accommodate a respective block, said at least one accommodation seat having at least one first region that is open downward and is designed to keep in contact the respective block and the aqueous solution contained in said supporting tray and at least second regions that are open upward at the position of the seeds in the block inserted therein so as to allow plant growth.
